(19) United States
(12) Patent Application Publication
(10) Pub. No.: US 2019/0354832 A1
(43) Pub. Date: Nov. 21, 2019

(54) METHOD AND SYSTEM FOR LEARNING ON GEOMETRIC DOMAINS USING LOCAL OPERATORS

(71) Applicant: Università della Svizzera italiana, Lugano (CH)

(72) Inventors: Michael BRONSTEIN, Cambridge, MA (US); Ron LEVIE, Tel Aviv-Yafo (IL); Federico MONTI, Cassina Rizzardi (IT)

(73) Assignee: Università della Svizzera italiana, Lugano (CH)

(21) Appl. No.: 15/982,609

(22) Filed: May 17, 2018

(51) Int. Cl. G06N 3/04; G06F 17/18; G06F 17/16; G06F 17/11; G06F 17/30

(52) U.S. Cl. CPC G06N 3/04; G06F 17/18; G06F 17/30958; G06F 17/11; G06F 17/16

(57) ABSTRACT

A method of extracting features from data defined on geometric domains such as community graphs is disclosed. The method suggests inputting central point data, neighbor point data, and neighbor edge data into an intrinsic local processing layer and applying at least one local operator and at least one operator function, wherein applying the at least one local operator comprises applying at least a local processing function to the data, and applying a local aggregation operation to aggregate the results of the local processing function. The local aggregated operation results are used to determine an output feature. The at least one operator function may be, for example, a Cayley polynomial or a Padé function.

### BACKGROUND

The present invention relates to the extraction of features from data. In more detail, the present invention deals with the problem of how to improve and successfully use deep learning methods, such as convolutional neural networks, on non-Euclidean geometric domains, overcoming the limitations currently affecting the prior art methods.

In general, available data often contains information relevant for a given task, but usually the available data needs to be processed to extract this information. For example, if the data represent the gray values of a large number of pixels that together form an image, a user might wish to extract as information what the image shows, e.g. a car, a face or a house and for this purpose, it is necessary to process the data to extract certain features there from.

Processing an input to determine specific features is known in both the analogue and the digital domain and different techniques exist for feature extraction.

As a simple example in the analogue domain, it might be necessary to determine fast, small variations of a signal that slowly varies over time with a large amplitude. This problem would typically best be described as isolating high frequency components from a signal component having a low frequency with a very large amplitude. These components can be easily isolated using filters, in the present case high pass filters. In other words, instead of describing signal processing in the time domain, the Fourier transformation of the input signal is considered and a specific processing in the frequency domain is suggested. It will be understood that the concept of transforming a given input into another domain frequently is helpful to isolate specific features and it will also be understood that methods such as filtering are not only applicable to analogue signals but also to digital data. It is worth noting that where a discrete signal is analyzed, for example a digitized signal, the Fourier spectrum will also consist of discrete frequencies. Also, concepts such as Fourier transformation have been applied not only to one-dimensional input data, but also for example in Fourier optics where the finer details of an image correspond to higher (spatial) frequencies while the coarse details correspond to lower (spatial) frequencies.

Transformation from one domain into another has proven to be an extremely successful concept in fields such as processing of electrical signals. Formally, what is done to determine the effect of filtering is transforming the initial signal into another domain, effecting the signal processing by an operation termed convolution and re-transforming the signal back. While the mathematical formalism of such “spectral” transformations is well known e.g. as Fourier transformations and while certain adaptions thereof are also well known for better signal processing, such spectral analysis techniques cannot be applied or used with certain type of data structures or input signals easily.

Another technique to determine specific information that has recently been successfully applied is deep learning.

Neural networks were inspired by biological processes. In a living organism, neurons that respond to stimuli are connected via synapses transmitting signals. The interconnections between the different neurons and the reactions of the neurons to the signals transmitted via the synapses determine the overall reaction of the organism.

In an artificial neural network, nodes are provided that can receive input data as “signals” from other nodes and can output results calculated from the input signals according to some rule specified a respective node. The rules according to which the calculations in each node are effected and the connections between the nodes determine the overall reaction of the artificial neural network. For example, artificial neurons and connections may be assigned weights that increase or decrease the strength of signals outputted at a connection in response to input signals. Adjusting these weights leads to different reactions of the system.

Now, an artificial neural network can be trained very much like a biological system, e.g. a child learning that certain input stimuli—e.g. when a drawing is shown—should give a specific result, e.g. that the word “ball” should be spoken if a drawing is shown that depicts a ball.

It however is important to keep in mind the limitations that are imposed on technical systems. For example, as indicated above, in order to determine whether a given image shows a cat, a house or a dog, the gray values of a large number of the pixels must be considered. Now, even for an image having a modest resolution, this cannot be done by considering all combinations of the gray value of any one pixel with the gray value of every of the other pixels. For instance, even an image of a mere 100 pixels×100 pixels would have 10000 weights for each neuron receiving one pixel. Neither processing nor training would be economically feasible in such a case using hardware available at the time of application.

Thus, what is done to reduce the number of parameters that need to be trained is to consider in a given step only small patches of the image, e.g. tiles of 5×5 pixels so that for every single pixel thereof only the rather small number such as 24 possible interconnections to the other 24 pixel of the patch need to be considered. In order to then evaluate the entire image, this is done in a tiling or overlapping manner; the respective results can then be combined or “pooled”. Thereafter, a further evaluation of the intermediate result and thereafter, a further pooling asf. can be effected until the final result is obtained.

As a plurality of layers is used and as the reaction of the system has to be trained, this is known as deep learning.

In the context of deep learning it is common to state that the “pooling” is done in pooling layers while the other steps are stated to be effected in processing layers. Also, it might be necessary to normalize input or intermediate values and this is stated to be done in normalization layers.

The processing can be done in a linear- or in a non-linear manner. For example, where a sensor network is considered producing as input values, e.g. pressure or temperature measurements, it is possible that large pressure differences or very high temperatures will change the behavior of material between the sensors, resulting in a non-linear behavior of the environment the set of sensors is placed in. In order to take such behavior into account, non-linear processing is useful. If in a layer, non-linear responses need to be taken into account, the layer is considered to be a non-linear layer.

Where the processing effected in a processing layer does not take into account the values of all other input or intermediate data but only considers a small patch or neighborhood, the processing layer is considered to be a “local” processing layer, in contrast to a “fully connected” layer.

A particularly advantageous implementation is a convolutional neural network (CNN), in which such a local processing is implemented in the form of a learnable filter bank. In this way, the number of parameters per layer is O(1), i.e., independent of the input size. Furthermore, the complexity of applying a layer amounts to a sliding window operation, which has O(n) complexity (linear in the input size). These two characteristics make CNNs extremely efficient and popular in image analysis tasks.

As the “pooling” layer typically combines results from a larger number of (intermediate) signals into a smaller number of (intermediate) output signals, the pooling layers are stated to reduce the dimensionality. It will be noted that different possibilities exist to combine a large number of intermediate signals into a smaller number of signals, e.g. a sum, an average or a maximum of the (intermediate layer input signals), an Lₚ-norm or more generally, any permutation invariant function.

Now, while from the above it can be concluded that classical deep neural networks applied in fields such as computer vision and image analysis consist of multiple convolutional layers applying a bank of learnable filters to the input image, as well as optionally pooling layers reducing the dimensionality of the input typically by performing a local non-linear aggregation operation (e.g. maximum), it is necessary to define suitable values for the learnable filters.

Accordingly, the neural networks needs to be trained and this usually necessitates to identify, even if not expressis verbis, specific features of a data set that either are or can be used to identify the information needed. Therefore, in using deep learning methods, features are extracted. As the layers in a deep neural network are arranged hierarchically, that is, data is going thru each of the layers in a specific predetermined sequence, the features to be extracted are hierarchical features.

However, while deep learning methods have been very successful for certain types of problems, e.g. image recognition or speech recognition, not all input data allow a satisfying application of existing methods. This is the case because currently a number of difficulties are encountered.

First of all, extraction of features becomes significantly time- and energy-consuming if the amount of data to be processed is increased. While in certain applications, this increase is more or less modest—for example, where features from an image having a particularly high resolution need to be extracted or where in speech recognition a longer speech needs to be transcribed, this problem can be quite significant for other applications. For example, the raw data obtained in sequencing a human genome produces some 3 TB of raw data and extracting information from genome data frequently necessitates evaluation of a large number of genomes.

Another example is extraction of features from networks, e.g. social networks having literally billions of members. If features are to be extracted from such extremely large sets of input data, for at least some of the methods previously used, time and energy needed for processing may become prohibitive.

It will be noted that while in simple examples such as image analysis, where it is obvious what a correct feature (“ball”, “house”) is, in certain application important features are both unknown and deeply hidden in the vast amount of data. For example, if a plurality of genomes are given from patients having either a certain type of cancer or being healthy, while it can be assumed that a certain specific pattern will be present in the genomes of the cancer patient, the pattern may not yet be known and needs to be extracted, but this extraction very obviously will be extremely computationally intensive. Extracting such features is either not feasible at all given the complexity of the problem or requires extremely long times using currently available resources and/or will require large amounts of energy. The same holds where features are to be extracted from entries in large social networks or streams of surveillance video data from a large number of cameras.

Furthermore, it should be noted that for some of the known methods used for extraction of features in order to be applicable, input data need to have a certain structure.

However, the structure of input data will vary largely. For example, pixels in a two dimensional image will be arranged on a two-dimensional grid and thus not only have a clearly defined, small number of neighbors but also a distance between them that is easy to define. A method of extracting features may thus rely on a distance between grid points as defined in standard Euclidean geometry.

In other instances, the data set will not have such a simple Euclidean structure, that is the data will be not Euclidean-structured data, i.e. as they do not lie on regular grids like images but irregular domains like graphs or manifold. In one specific example, data points might be arranged on a surface. It might be noted that certain types of surfaces might be defined as implicit surfaces, that is surfaces that in an Euclidean space are defined by an equation F(x,y,z)=0. Also, a surface might be defined to be a parametric surface embedded into a Euclidean space. Where the surfaces have specific properties such as a sphere, it is well known that the surface is non-Euclidean and that, more particular, they may constitute so-called Riemannian manifolds. In computer graphics and vision, 3D objects are generally modeled as Riemannian manifolds (surfaces) that have certain properties such as color texture. It will be noted that when reference is made to modelling a 3D object, it usually will be sufficient to consider only certain points on or within the model. For example, where an object to be modeled has a smooth surface, it will generally be considered sufficient to consider only a limited number of such points distributed in a suitable manner across the surface of the object so that e.g. an interpolation between the points can be effected. Usually, meshes of polygons such as triangles are used to approximate the surface. The average skilled person will understand that where such a Riemannian manifold is considered, in general a small patch around a data point will obey Euclidean geometry.

Then, in some instances, the data structure will be neither Euclidean nor a Riemannian manifold.

As an example for a non-Euclidean data structure graphs or networks should be mentioned. Some examples of graphs are social networks in computational social sciences, sensor networks in communications, functional networks in brain imaging, regulatory networks in genetics, and meshed surfaces in computer graphics.

Generally speaking, graphs comprise certain objects and indicate their relation to each other. The objects can be represented by vertices in the graph, while the relations between the objects are represented by the edges connecting the vertices. This concept is useful for a number of applications. For example, in a social networks, the users could be represented by vertices and the characteristics of users can be modeled as signals on the vertices of the social graph. In a sensor networks the graph models distributed interconnected sensors, whose readings are modelled as time-dependent signals on the vertices. In genetics, gene expression data are modeled as signals defined on the regulatory network. In neuroscience, graph models can be used to represent anatomical and functional structures of the brain.

Such graphs may interconnect only similar data objects, e.g. users of a social network, or they may relate to different objects such as dog owners on the one hand and their dogs on the other hand. Accordingly, the graph can be homogeneous or heterogeneous.

Graphs may be directed or undirected. An example of a network having a directed edge is a citation networks, where each vertex represents a scientific paper and a directed edge is provided from a first to a second vertex if the paper represented by the first vertex is cited in the paper represented by the second vertex. An example for a network having undirected edges is a social network where an edge between two vertices is provided only if the two subjects represented by the vertices mutually consider each other as “friends”. It will be noted that it is possible to define a neighborhood around a vertex, where direct neighbors are those to which a direct edge connection is provided and wherein a multi-hop neighborhood can be defined as well in a manner counting the number of vertices that need to be passed to reach a “p-hop” neighbor.

A graph may have specific recurring motifs. For example, in a social network, members of a small family will all be interconnected with each other, but then each family member will also have connections to other people outside the family that only the specific member will know. This may result in a specific connection pattern of family members. It may be of interest to identify such patterns or “motifs” and to extract features from data that are specific to the interaction of family members and it might be of particular interest to restrict data extraction to such motifs.

It should also be considered that sometimes, it is not sufficient to only consider the differences neighboring vertices show between their absolute values. For example, where a network of temperature sensors is used, it may be taken into account that the thermal conductivity of the material between two sensors as well as the geometrical distance in determining an edge function that relates to flow of thermal energy may vary. This can be done using edge functions.

Thus, if in a pooling layer from a larger number of (intermediate) signals a smaller number of (intermediate) output signals is determined as an aggregate, it may be necessary to take into account not only the values at each vertex but also the values of an edge function.

From the above, it is to be understood that in computing a plurality of edge features, a nonlinear edge function could be applied for each neighbor point on the pair of central point feature and neighbor point feature.

It will also be understood that it is possible to define any of a central point function, a neighbor point function and an edge function as a parametric function. The functions can be implemented as neural networks.

As another example for a non-Euclidean data structure a point cloud should be mentioned, that is, a set of data points in space. Point clouds are generally produced e.g. by 3D scanners, such as coordinate measuring machines, used in metrology and quality inspection, and for a multitude of visualization, animation, rendering and mass customization applications. While it would be possible to assign each point of the cloud certain coordinates in real space, so that a use can be made of concepts relying on neighboring points, there will not be any interconnection of the data points, at least not initially prior to some data processing.

Accordingly, a large variety of different data structures exists for which it might be of interest to a user to extract certain features and where the data points have a specific relation to each other that allows to consider the data points to reside on a geometric domain. It is to be noted that the examples for such data structures given above are not limiting and that other data structures that might also be considered to be geometric domains and that in the context of the present invention, the term “geometric domain” might inter alia and without limitation refer to continuous non-Euclidean structures such as Riemannian manifolds, or discrete structures such as directed-, undirected and weighted graphs or meshes.

Now, as has been stated above, while a Fourier transformation is straightforward to use in certain types of signal processing and is well known in certain areas, using such spectral techniques is far from straightforward for other types of data or data structures, in particular where the features are to be extracted from geometric domains in general without restriction to Euclidean geometry.

It will be understood that for extracting features from geometric domains, deep learning methods have already been used. It will also be understood that it would be preferred to combine spectral methods of data extraction with methods such as deep learning on geometric domains.

The earliest attempts to apply neural networks to graphs are due to Scarselli, F., Gori, M., Tsoi, A. C., Hagenbuchner, M., Monfardini, G. The graph neural network model. IEEE Transactions on Neural Networks 20(1):61-80, 2009).

Regarding deep learning approaches, and in the recent years, deep neural networks and, in particular, convolutional neural networks (CNNs), reference is made to LeCun, Y., Bottou, L., Bengio, Y., Haffner, P. Gradient-based learning applied to document recognition. Proc. IEEE, 86(11):2278-2324, 1998. The concepts discussed therein have been applied with great success to numerous computer vision-related applications.

With respect to extending classical harmonic analysis and deep learning methods to non-Euclidean domains such as graphs and manifolds, reference is made to Shuman, D. I., Narang, S. K., Frossard, P., Ortega, A., Vandergheynst, P. The emerging field of signal processing on graphs: Extending high-dimensional data analysis to networks and other irregular domains. IEEE Signal Processing Magazine, 30(3):83-98, 2013; and Bronstein, M. M., Bruna, J., LeCun, Y., Szlam, A., Vandergheynst, P. Geometric deep learning: going beyond Euclidean data. arXiv: 1611.08097, 2016.

Bruna, J., Zaremba, W., Szlam, A., and LeCun, Y. in “Spectral networks and locally connected networks on graphs” Proc. ICLR 2014 formulated CNN-like deep neural architectures on graphs in the spectral domain, employing the analogy between the classical Fourier transforms and projections onto the eigenbasis of the so-called graph Laplacian operator that will be explained in more detail hereinafter.

In the follow-up work Convolutional neural networks on graphs with fast localized spectral filtering by Defferrard, M., Bresson, X., and Vandergheynst, P. in Proc. NIPS 2016) an efficient filtering scheme using recurrent Chebyshev polynomials was proposed, which reduces the complexity of CNNs on graphs to the same complexity of standard CNNs on regular Euclidean domains.

In a paper entitled “Semi-supervised classification with graph convolutional networks” arXiv:1609.02907, 2016, Kipf, T. N. and Welling, M. proposed a simplification of Chebyshev networks using simple filters operating on 1-hop neighborhoods of the graph.

In “Geometric deep learning on graphs and manifolds using mixture model CNNs”. Proc. CVPR 2017, Monti, F, Boscaini, D., Masci, J., Rodola, E., Bronstein, M. M. introduced a spatial-domain generalization of CNNs to graphs using local patch operators represented as Gaussian mixture models, showing a significant advantage of such models in generalizing across different graphs.

However, the known methods hitherto have not been completely satisfying, in particular, where efforts have been made to combine geometric deep learning methods with spectral techniques for feature extraction. In this context, it is worthwhile to note that generally, geometric deep learning is an umbrella term referring to extensions of convolutional neural networks to geometric domains, in particular, to graphs.

Such neural network architectures are known under different names, and are referred to as intrinsic CNN (ICNN) or graph CNN (GCNN). Note that a prototypical CNN architecture consists of a sequence of convolutional layers applying a bank of learnable filters to the input, interleaved with pooling layers reducing the dimensionality of the input. A convolutional layer output is computed using the convolution operation, defined on domains with shift-invariant structure, e.g. in discrete setting, regular grids. A main focus here is in on special instances, such as graph CNNs formulated in the spectral domain, though additional methods were proposed in literature. Reference is made in particular to M. M. Bronstein, J. Bruna, Y. LeCun, A. Szlam, P. Vandergheynst, Geometric deep learning: going beyond Euclidean data, IEEE Signal Processing Magazine 34(4): 18-42, 2017.

The disadvantages of methods known in the art will now be explained in more detail using graphs as an example and introducing certain concepts in a more precise manner.

For this, a graph [symbol] =( [symbol] , [symbol] , W) is considered that consists of a set [symbol] ={1, . . . , n} of n vertices, a set [symbol] ={(i,j): i,j∈ [symbol] }⊆ [symbol] × [symbol] of edges (an edge being a pair of vertices), on which a weight is defined as follows: wᵢⱼ>0 if (i,j)∈ [symbol] and wᵢⱼ=0 if (i,j)∉ [symbol] .

The weights can be represented by an n×n adjacency (or weight) matrix W=(wᵢⱼ). The graph is said to be undirected whenever (i,j)∈ [symbol] iff (j,i)∈ [symbol] for all i,j, and is directed otherwise. For undirected graphs, the adjacency matrix is symmetric, W^{T}=W.

Furthermore, we denote by
x=(x₁, . . . , xₙ)^{T} functions defined on the vertices of the graphs

One can then construct the (unnormalized) graph Laplacian as an operator acting on the vertex functions, in the form of a symmetric positive-semidefinite matrix where the

graph Laplacian is Δ=D−W,

with D=diag(Σ_{j≠i}wᵢⱼ) being the diagonal degree matrix, containing at position i,i the sum of all weights of edges emanating from vertex i. For undirected graphs, Δ is a symmetric matrix.

The Laplacian is a local operation, in the sense that the result of applying the Laplacian at vertex i is given by

(Δf)ᵢ=Σ_{j:ij∈ε}wᵢⱼ(xᵢ−xⱼ) (1)

In other words, the result obtained from applying the Laplacian is influenced only by the value at a vertex and its neighborhood. Equation (1) can be interpreted as taking a local weighted average of x in the neighborhood of i, and subtracting from it the value of xᵢ.

It should be noted that locality is an important concept for a large number of applications as it not only has significant advantages when processing data but also is important where real physical entities are considered.

It will be noted that in the example of a graph having vertices and edges as discrete elements, locality can be understood by referring only to those other elements that can be reached “hopping” along edges from vertex to vertex, so that a 1-hop, 2-hop, 3-hop asf. neighborhood can be defined. However, locality can also be defined where the underlying geometric domain is continuous rather than discrete. There, locality would be given if Δf only depends on an infinitesimally small neighborhood.

Thus, the graph Laplacian is only a particular example of a local operator that can be applied on data on a geometric domain in general, and a graph in particular.

The geometric interpretation of the Laplacian given above is that a (weighted) averaging of the data in the neighborhood of a vertex and subtracting the data at the vertex itself is performed. This operation is linear in its nature. However, it will be understood that other operators exist that will provide for local processing and will be linear.

Accordingly, it will be noted that rather than specifically referring to the graph Laplacian defined above, reference could be made to other such local operators in general and it will be understood that different local operators exist, e.g. adapted to specific geometric domains, so that inter alia graph Laplacian operators, graph motif Laplacian operators, point-cloud Laplacian operators, manifold Laplace-Beltrami operator or mesh Laplacian operators are known and could be referred to and used. It will thus be understood that the invention can be applied by a person skilled in the art to other definitions of graph Laplacians; furthermore, the definition of Laplacians on other geometric domains, both continuous and discrete, is analogous to the above definitions and therefore the constructions presented hereinafter can be applied to general geometric domains by a person skilled in art. It will be obvious that a specific Laplacian may or should be used because either a specific data structure is given or because specific needs are addressed.

For example, it is possible to define processing operators based on small subgraphs (called motifs) that can handle both directed and undirected graphs.

This being noted, let us return to the example of an undirected graph and its symmetric graph Laplacian.

It can be shown that such a Laplacian admits an eigendecomposition of the form

Δ=ΦΛΦ^{T},

where
Φ=(ϕ₁, . . . ϕₙ) denotes the matrix of orthonormal eigenvectors
and
Λ=diag(λ₁, . . . , λₙ) denotes the diagonal matrix of the corresponding eigenvalues.

Where in classical harmonic analysis of a discrete signal, a discrete Fourier transformation is determined, only certain fixed frequencies (referred to as “Fourier atoms”) are considered rather than considering a continuous spectrum. In the example, the eigenvectors play the role of these Fourier atoms in classical harmonic analysis and the eigenvalues can be interpreted as their frequencies.

With this analogy, given a function
x=(x₁, . . . , xₙ)^{T} on the n vertices of the graph,
   its graph Fourier transform can be defined as being given by

\hat{x}=Φ^{T}x.

Again, by analogy to the Convolution Theorem in the Euclidean case, the spectral convolution “*” of two functions x, y can then be defined as the element-wise product of the respective Fourier transforms,

x★y=Φ(Φ^{T}y)∘(Φ^{T}x)=Φ diag(ŷ₁, . . . , ŷₙ)\hat{x} (2)

Note, that this convolution can be determined if the matrix Φ is known from the eigendecomposition of the Laplacian.

This approach has been used in the prior art to implement filters in the spectral domain for graphs. In more detail, J. Bruna, W. Zaremba, A. Szlam, Y. LeCun in “Spectral Networks and Locally Connected Networks on Graphs”, Proc. ICLR 2014) used the spectral definition of convolution (2) to generalize CNNs on graphs.

To this end, a spectral convolutional layer in this formulation is used that has the form

$${\tilde{x}}_{l} = ξ ( {\sum }_{{l}^{′} = 1}^{{q}^{′}} Φ {\hat{Y}}_{{ll}^{′}} {Φ}^{⊤} {x}_{{l}^{′}} ) , l = 1 , … , q , \qquad ( 3 )$$

where
q′ and q denote the number of input and output channels (or “data entries”) that are inputted into and outputted from the layer, respectively,
Y_{ll′} is a diagonal matrix of spectral multipliers representing a filter in the spectral domain; note that this filter is learnable, that is, the filter values would be adjusted by training.
ξ is a nonlinearity, e.g. hyperbolic tangent, sigmoid, or rectified linear unit (ReLU) applied on the vertex-wise function values.
   and, as before
x=(x₁, . . . , xₙ)^{T} is a function defined on the vertices of the graph,
Φ=(ϕ₁, . . . ϕₙ) again denotes the matrix of orthonormal eigenvectors resulting from the eigendecomposition of the Laplacian.

Thus, according to equation (3), the output of the convolutional layer is obtained by determining for each input q′ a function x_{l′}, to which a filter as described by Y_{ll′} is applied and then the respective signals obtained from all inputs (or data entries) q′ treated in this manner are aggregated and a nonlinear result is derived from the aggregate using ξ.

However, unlike classical convolutions carried out efficiently in the spectral domain using FFT, this is significantly more computationally expensive.

First, as there are no FFT-like algorithms on general graphs for the computations of the forward and inverse graph Fourier transform, multiplication by the matrices Φ, Φ^{T} are necessary, having a complexity of O(n²), where here and in the following we use the “Big-O notation” to denote complexity order.

Secondly, the number of parameters representing the filters of each layer of a spectral CNN is O(n), as opposed to O(1) in classical CNNs.

Third, there is no guarantee that the filters represented in the spectral domain are localized in the spatial domain, which is another important property of classical CNNs. In other words, applying the filter might lead to a situation where the output from a given patch of the geometric domain might be influenced by values of points outside the patch, potentially from points very far away on the domain.

Hence, this simple approach known in the art has severe drawbacks. A further approach has been suggested by M. Defferrard, X. Bresson, P. Vandergheynst in “Convolutional Neural Networks on Graphs with Fast Localized Spectral Filtering, Proc. NIPS 2016).

For using what is known as Chebyshev Networks (or ChebNet) according to Defferrard et al., a rescaled Laplacian having all of its eigenvalues all in the interval [−1,1] is used. It is noted that such a rescaled Laplacian can be obtained from a non-rescaled Laplacian by defining

\tilde{Δ}=2λₙ⁻¹Δ−I

where
\tilde{Δ}=2λₙ⁻¹Δ−I is the rescaled Laplacian
   and
\tilde{Λ}=2λₙ⁻¹Λ−I are the eigenvalues of the rescaled Laplacian in the interval [−1,1].

Now, a polynomial filter of order p (in some cases, represented in the Chebyshev polynomial basis can be defined as

$${τ}_{θ} ( \tilde{λ} ) = {\sum }_{j = 0}^{p} {θ}_{j} {T}_{j} ( \tilde{λ} ) , \qquad ( 4 )$$

where
\tilde{λ} is the frequency rescaled in [−1,1],
θ is the (p+1)-dimensional vector of polynomial coefficients parameterizing the filter,
   and
Tⱼ(λ)=2λTⱼ₋₁(λ)−Tⱼ₋₂(λ) denotes the Chebyshev polynomial of degree j defined in a recursive manner with T₁(λ)=λ and T₀(λ)=1.

This known approach benefits from several advantages.

First, the filters are parameterized by O(1) parameters, namely the p+1 polynomial coefficients.

Second, there is no need for an explicit computation of the Laplacian eigenvectors, as applying a Chebyshev filter a function x=(x₁, . . . , xₙ)^{T} defined on the vertices on a simply amounts to determining the right side of equation (5) given by

τ_{θ}(\tilde{Δ})x=Σⱼ₌₀^{p}θⱼTⱼ(\tilde{Δ})ₓ (5)

Now, first, due to the recursive definition of the Chebyshev polynomials, this only incurs applying the Laplacianp times with p being the polynomial degree.

Then, second, multiplication by a Laplacian has the cost of O(|ε|), and assuming the graph has |ε|=O(n) edges, which is the case for k-nearest neighbors graphs and most real-world networks, the overall complexity is O(n) rather than O(n²) for equation (3) operations, similarly to classical CNNs.

Third, since the Laplacian is a local operator affecting only 1-hop neighbors of a vertex and accordingly its pth power affects only the p-hop neighborhood, so the resulting filters are spatially localized.

Thus, Chebyshev networks effectively already reproduce the computationally appealing characteristics of classical Euclidean CNNs.

However, while appealing due to its conceptual simplicity, the application of spectral graph CNNs and Chebyshev networks in particular still suffer from multiple important drawbacks.

### [Drawbacks of Existing Methods]

First, in many cases polynomials turn out to be very poor approximates of some functions. Polynomials can represent only filters with finite spatial support that have slow decay in the spectral domain; this is the analogy of Finite Impulse Response (FIR) filters in classical signal processing on Euclidean domains.

Filters with rapid spectral decay (i.e., those whose Fourier transform coefficients become small very fast as the frequency increases; such filters are typically called low-pass filters) tend to be delocalized due to the Heisenberg uncertainty principle (a fundamental property of the Fourier transform stating that the product of the variance of a signal and that of its Fourier transform is lower-bounded and cannot be made arbitrarily small, implying that spatial localization leads to spectral delocalization and vice versa) and may require polynomials of very high degree. As can be seen above, a filter with a rapid spectral decay would require a Chebyshev polynomial of high order, leading to effects of data points as far away asp-hops and thus with high order, the filter becomes more and more delocalized. Also, the higher order polynomials tend to be numerically unstable.

FIG. 3A depicts an example of a community graph. Graphs of this type are characterized by clusters of small (approximately zero) eigenvalues equal to the number of communities present in the graph. In tasks such as community detection, the important information is contained in the lower part of the spectrum (near-zero frequencies 300). Localizing polynomial filters is very hard in this setting, as shown in FIG. 4B.

It might be understood by referring to classical approximation theory that other approximation methods using rational functions such as Cayley or Padé schemes offer significant advantages over simple polynomials; in classical signal processing, such filters are known as rational filters yielding an Infinite Impulse Response (IIR).

Second, these filters perform poorly on complex local structures. This is due to the properties of the Laplacians that induce isotropic kernels. On a regular 2D grid, the Laplacian is rotation-invariant, implying that the resulting Chebyshev filters have a circular symmetry, as visualized in FIGS. 3A-3C. However, this may be disadvantageous as such circular features often do not correspond well to an underlying geometric domain and thus perform poorly and fail to capture complex local structures.

Third, the spectral filtering approach is explicitly based on the assumption that the Laplacian is a symmetric operator admitting orthogonal eigendecomposition, which in turn necessitates that the underlying graph is undirected. It is noted that the above explanation explicitly related to an undirected graph. Directed graphs with asymmetric Laplacians (an example is shown in FIGS. 2A & 2B) cannot be simply treated by the above framework.

Fourth, the Laplacian operator is a rather simplistic operation. As indicated above, the Laplacian operator geometrically is performing a (weighted) average of the function in the neighborhood of a point and subtracting it from the value of the function at the point itself. In many settings, this simple approach might produce only features that are too poor.

Fifth, the described framework treats only scalar edge weights in the definition of the Laplacian operator and does not generalize straightforwardly to more complex edge-based functions. In many settings, the graph can contain important data both on the vertices and edges.

Last but not least, spectral CNNs suffer from poor generalization across different domains. The reason is that the filters are expressed with respect to a basis, namely the Laplacian eigenbasis, which however can be shown to vary across non-isometric domains (FIGS. 6A-6C). In practice, only very smooth spectral filters (FIG. 5A) tend to generalize well across domains, while non-smooth filters (FIG. 5B) tend to produce unstable results even on near-isometric domains.

Accordingly, a number of problems exist that prevent the application of filters on general geometric domains.

### OBJECT OF THE INVENTION

In light of the above, it is an object of the present invention to extract features from data defined on a geometric domain. It is a further object of the present invention to extract features from data entries by means of efficient local operations that can be parameterized by a set of parameters and can be combined together in a hierarchical manner.

It is a further object of the present invention to extract features from data defined on a geometric domain that allows to extract features in a manner relaxing the requirements on the available hardware resources used for the extraction process and the energy consumption thereof.

### BRIEF SUMMARY OF THE INVENTION

The present invention proposes to address the aforementioned issues by an improved approach.

In a first embodiment, what is suggested is a method for extracting hierarchical features from input data defined on a geometric domain, the method comprising applying at least one intrinsic local processing layer on local processing layer input data, at least a part of which being derived from or corresponding to input data and comprising central point input data, neighbor point input data, and neighbor edge input data, to obtain intrinsic local processing layer output data by inputting intrinsic local processing layer input data into the intrinsic local processing layer; applying at least one local operator; and applying at least one operator function, wherein said at least one local operator is applied to at least some of the intrinsic local processing layer input data in a manner comprising the steps of—applying at least a local processing function to at least some of the central point input data, neighbor point input data, and neighbor edge input data—applying a local aggregation operation to aggregate at least one of the results of said local processing functions—using at least said local aggregation operation result to output an output feature corresponding to said point and wherein said operator function comprises applying to said at least one local operator at least one or more of the following operations—multiplication by a non-trivial real or complex scalar—nonlinear scalar function—operator addition—operator multiplication—operator composition—operator inversion and wherein the intrinsic local processing layer output data is used to extract the hierarchical features.

Preferably, applying the local processing function further comprises applying a central point function to at least some of the central point input data to compute a central point feature; for at least some of the neighbor points, applying a neighbor point function to at least some of the neighbor point input data to compute a neighbor point feature; for at least some of the neighbor points, applying an edge function to at least some of the pairs of at least central point feature and neighbor point feature, to compute a neighbor edge feature; applying a local aggregation operation to aggregate at least some of said neighbor edge features; and using at least said local aggregation operation result to output the output feature corresponding to said point.

It is preferred if the intrinsic local processing layer comprises first applying the at least one local operator and then applying the at least one operator function.

Preferably, at least one of the operator functions is at least one of the following: a polynomial; a rational function; a Cayley polynomial; a Padé function.

Preferably, at least one intrinsic local processing layer comprises more than one local operator, and wherein the at least one of the operator functions is a multivariate function applied to more than one local operator, in particular wherein at least one of the multivariate functions is a one of the following a multivariate polynomial; a multivariate rational function; a multivariate Cayley polynomial; a multivariate Padé function.

Preferably, the at least one local operator is at least one of the following: graph Laplacian operator; graph motif Laplacian operator; point-cloud Laplacian operator; manifold Laplace-Beltrami operator; mesh Laplacian operator, in particular wherein a plurality of local processing operators are applied and at least some of the local processing operators are graph motif Laplacian operators corresponding to a plurality of graph motifs, and at least one operator function is a multivariate function applied to said graph motif Laplacian operators.

Preferably, a plurality of local processing functions are applied and at least some of the local processing functions are parametric functions, and/or they are implemented as neural networks.

Preferably, at least some of the central point functions; neighbor point functions; and edge functions are parametric functions and/or are implemented as neural networks.

Preferably, at least one of the operations effected by at least one operator function on the at least one local operator includes an operator inversion and the operator inversion is carried out in an iterative manner. In a particular preferred variant, this is done such that where the number of iterations is fixed and/or such that the operator inversion is carried out by means of one of a Jacobi method, a conjugate gradients method; a preconditioned conjugate gradients method; a Gauss-Seidel method; a minimal residue method; a multigrid method. Also, preferably, at least some iterations of an iterative algorithm used to carry out the operator inversion are implemented as layers of a neural network.

Preferably, the geometric domain is at least one of the following: a manifold; a parametric surface; an implicit surface; a mesh; a point cloud; a directed graph; an undirected graph; a heterogeneous graph.

Preferably, the input data defined on a geometric domain comprises at least one of vertex input data and edge input data.

Preferably, the at least one local aggregation operation is at least one or more of the following: a permutation invariant function; a weighted sum; a sum; an average; a maximum; a minimum; an Lp-norm; a parametric function; a neural network. Also, preferably, at local aggregation operation may be a parametric function and/or may be implemented as a neural network.

Preferably, the method according to the invention further comprises applying at least one of the following layers: a linear layer or fully connected layer, outputting a weighted linear combination of layer input data; a non-linear layer, including applying a non-linear function to layer input data; a spatial pooling layer, including: determining a subset of points on the geometric domain, determining for each point of said subset, neighboring points on the geometric domain, and computing a local aggregation operation on layer input data over the neighbors for all the points of said subset; a covariance layer, including computing a covariance matrix of input data over at least some of the points of the geometric domain; and wherein each layer has input data and output data, and wherein output data of one layer are forwarded as input data to another layer.

Preferably, the applied layer has parameters, said parameters comprising at least one or more of the following: weights and biases of the linear layers; parameters of the intrinsic local processing layers, comprising at least one or more of the following: parameters of the local processing operators; parameters of the local processing functions; parameters of the local aggregation operations; parameters of the central point functions; parameters of the neighbor point functions; parameters of the edge functions; parameters of the operator functions;

Preferably, parameters of the operator function comprise at least one or more of the following: —coefficients of a polynomial; —coefficients of a multivariate polynomial; —coefficients of a Cayley polynomial; —coefficients of a multivariate Cayley polynomial; —coefficients of a Padé function; —coefficients of a multivariate Padé function; —spectral zoom. In particular, parameters of the applied layers are determined by minimizing a cost function by means of an optimization procedure.

In a further embodiment, a system for extracting hierarchical features from a set of data defined on a geometric domain is suggested, the system comprising at least one interface for inputting input data into the system and for outputting output data by the system, the system further comprising means for applying at least one intrinsic local processing layer on local processing layer input data, means for determining the local processing layer input data in response to input data comprising central point input data, neighbor point input data, and neighbor edge input data to obtain intrinsic local processing layer output data, the means for applying at least one intrinsic local processing layer on local processing layer input data being adapted to input intrinsic local processing layer input data into the intrinsic local processing layer; to apply at least one local operator; and to apply at least one operator function, and being adapted such that said at least one local operator is applied to at least some of the intrinsic local processing layer input data in a manner comprising applying at least a local processing function to at least some of the central point input data, neighbor point input data, and neighbor edge input data, applying a local aggregation operation to aggregate at least one of the results of said local processing functions, using at least said local aggregation operation result to output an output feature corresponding to said point and such that said operator function comprises applying to said at least one local operator at least one or more of the following operations: multiplication by a non-trivial real or complex scalar, nonlinear scalar function, operator addition, operator multiplication, operator composition, operator inversion, and wherein the means for applying said at least one intrinsic local processing layer on local processing layer input data being adapted to use the intrinsic local processing layer output data to extract the hierarchical feature.

It is preferred if this system comprises means for applying a plurality of at least a first and a second layer in a sequential manner such that the first layer is applied first and the second layer is applied thereafter, and furthermore comprising a means for allowing use of the output data of the first layer to determine input data to the second layer and configured such that different data processing devices are provided for applying the first layer and the second layer respectively and a communication path is provided to propagate the output data of the first layer towards the second layer, so that input data to the second layer can be determined therefrom; and/or such that a storage is provided for storing output data of the first layer so that input data into the second layer can be determined at a later time by retrieving the stored output data from the storage.

### BRIEF DESCRIPTION OF THE DRAWINGS

FIG. 1A depicts a neighborhood of a point on geometric domain and data associated therewith;

FIG. 1B depicts the computation of a Laplacian operator on a geometric domain;

FIG. 1C depicts different neighborhoods of two different points on a geometric domain;

FIGS. 2A-2D depict the construction of motif Laplacians on a directed graph;

FIG. 2E depicts graph motifs;

FIGS. 3A-3C depict polynomial and rational spectral filters;

FIGS. 4A-4C depict the application of polynomial and rational spectral filters to a community graph;

FIGS. 5A & 5B depict smooth and non-smooth spectral filters and the results of their application on a geometric domain;

FIGS. 6A-6C depict the results of application of a spectral filter on different geometric domains;

FIGS. 7A-7C depict the spectral zoom of the Cayley filter for various values of the spectral zoom parameter h;

FIG. 8 depicts the computational complexity of Cayley filters using full and approximate Jacobi matrix inversion;

FIG. 9 depicts the accuracy of community detection with Cayley filters using different filter order p and number of Jacobi iterations K;

FIGS. 10A-10C depict the local operator according to some embodiments of the invention;

FIG. 11 depicts the processing functions according to some embodiments of the invention.

### DETAILED DESCRIPTION OF THE INVENTION

The present invention will now be described in more detail with respect to preferred embodiments as shown in the figures.

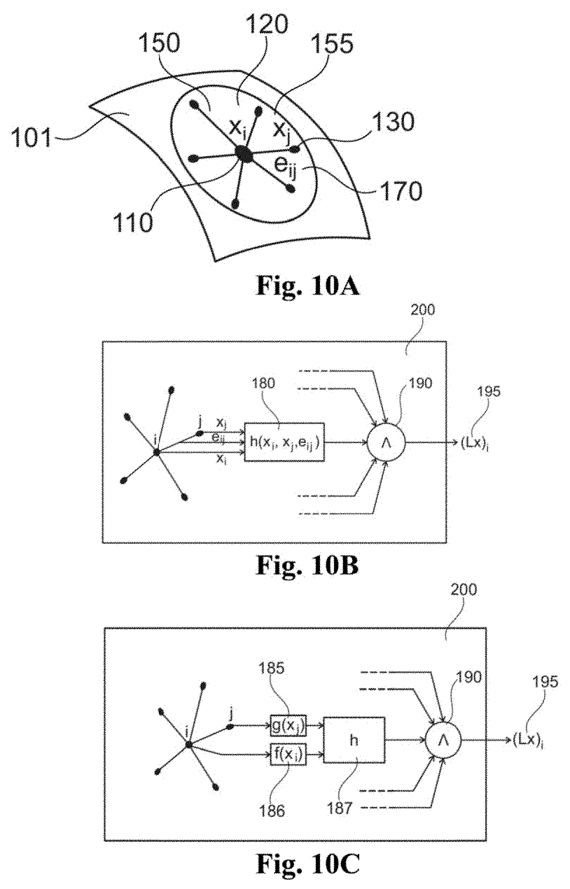

According to the invention, an important aspect will be explained with respect to FIGS. 10A-10C & 11. According to this aspect, two key components are used in a combined manner, namely a local operator 200 and an operator function 250, where the numbers refer to FIGS. 10A-10C & 11.

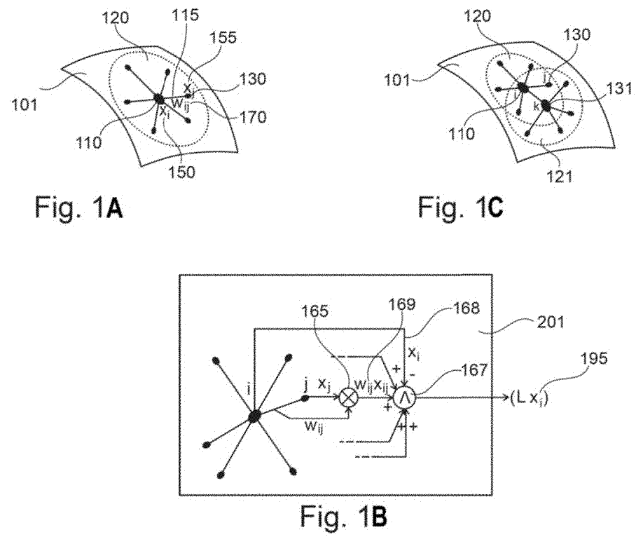

In FIG. 1A, a geometric domain 101 is shown. The domain comprises a number of points such as points with indices i 110 and j 130 and edges (ij) 115 that run between points i 110 and j 130. In FIG. 1A, one point i 110 is shown as a central point together with all points that are connected to i and that are thus for a neighborhood 120 of point i. It will be understood however that the method of the invention is carried out in a manner such that, overall, not only one single point i is considered as a central point but that in a preferred embodiment each point of the domain will at some instance be considered a central point as shown in FIG. 1C; at the other times, that is when a given point i 110 currently is not considered as a central point, another point, say k 131 will be considered as central point and i 110 may then be a point either or not having an edge to the point k (like shown in FIG. 1C) so that the neighborhood 121 of point k may contain some points from the neighborhood 120 of point i, including point i itself.

To extract information—or features—from all the data associated with the points on the domain (such as data xᵢ 150 and xⱼ 155 in FIG. 1A) and the edges and the information assigned to the edges (such as data eᵢⱼ 170), without necessitating extreme processing power, extreme data storage access, even though the data set may be extremely large, what is suggested by the present invention is that in a basic building block 255 of various embodiments of the present invention, —one or more local operators 200 is applied to data on a geometric domain 101, followed by an operator function 250. Where this is done using an intrinsic deep neural network architecture, such an intrinsic deep neural network architecture may consist or make use of one or more sequences of such basic operations. Like in classical neural networks, such intrinsic layers can be interleaved with pooling operations, fully connected layers, and non-linear functions.

Both the local operator and the operator functions can have learnable parameters.

In some embodiments of the invention, both or any of the local operator and the operator functions can themselves be implemented as small subgraph operators and operator functions respectively.

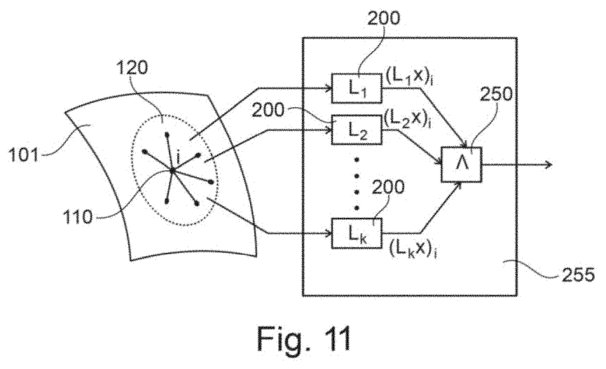

In some embodiments of the invention (as exemplified in FIG. 11), more than a single local operator 200 may be used, each of which having different, shared, or partially shared learnable parameters. Where this is the case, some or any the local operator and the operator functions can have learnable parameters.

To explain in even more detail the method, consider a local operator 200 be defined as follows.

### Let

x: [symbol] → [symbol] ^{d}^{_{ν}}
   and
e: [symbol] → [symbol] ^{d}^{_{ε}}
   be general vector-valued functions defined on the vertices and edges of the graph, respectively,
   that can be represented as matrices
X of size n×d_{ν}
   and
E of size | [symbol] |×d_{ε}, respectively.

While for simplicity in some of the examples given below, it is assumed that all the values are real, it is understood that a person skilled in art can apply the present invention to the setting when complex-values functions are used.

Furthermore, let
i∈ [symbol] be a vertex (or point, both terms used interchangeably) 110 of a graph or more generally, a geometric domain,
   and let
[symbol] ⊂ [symbol] be the neighborhood 120 of i;
   for simplicity of discussion, we consider a particular case of 1-ring [symbol] ={j: ij∈ [symbol] }) though other neighborhoods can be used in the present invention by a person skilled in art.

Considering a single vertex (or point) 110 i on the geometric domain 101, we thus have the central point data xᵢ, for each of j∈ [symbol] ᵢ, neighbor point data xⱼ, and neighbor edge data eᵢⱼ, denoted by numbers 150, 155, and 170, respectively in FIG. 10A.

The result of a local operator L at point i can then be defined as follows:

$${( L ( X , E ) )}_{i} = {}_{j ∈ {𝒩}_{i}} h ( {x}_{i} , {x}_{j} , {e}_{ij} ) \qquad ( 6 )$$

where
h: [symbol] ^{2d}^{_{ν}}^{+d}^{_{ε}}→ [symbol] ^{d′}^{_{ν}} is a local processing function 180 that can be either a fixed function or a parametric function with learnable parameters;
   and
∧ is a local aggregation operation 190, e.g. (weighted) sum, mean, maximum, or in general, any permutation-invariant function.

Note that the local aggregation operation ∧ generates an output in response to both the processing of the central point data xᵢ 150

and the processing of all of the data of neighboring points eᵢⱼ 155 and the edge data eᵢⱼ 170. Hence, this is a local aggregation in the sense that what is aggregated is the (local) neighborhood 120 of a central point 110.

The aggregation operation 190 can also be parametric with learnable parameters. Note that the function h is sensitive to the order of features on points i and j, and hence can handle directed edges.

In one of the embodiments of the invention, as a particularly convenient form of the local processing function what is used is a local processing function

h(ƒ(xᵢ),g(xⱼ))

where
ƒ: [symbol] ^{d}^{_{ν}}→ [symbol] ^{d′}^{_{ν}} is a central point function 186,
g: [symbol] ^{d}^{_{ν}}→ [symbol] ^{d″}^{_{ν}} is a neighbor point function 185,
   and
h: [symbol] ^{d′}^{_{ν}}^{+d″}^{_{ν}}♯ [symbol] ^{d′″}^{_{ν}} is the edge function 187.

The functions ƒ, g, h can be either fixed or parametric with learnable parameters.

One implementation of the graph Laplacian (exemplified in FIG. 1B) then is a particular example of a local operator L with h=xᵢ−xⱼ and ∧=Σ is the (weighted) summation operation. In this setting, h is invariant to the order of the vertices i and j.

A non-linear Laplacian-type operator can be obtained by using an edge function of the form h (ƒ(xᵢ)−g(xⱼ)). The local operator L can thus be either linear of non-linear.

Furthermore, more than a single operator may be involved. This is exemplified in FIG. 11 where different operators L₁, . . . , L_{K} are shown to be applied to xᵢ.

To the local operator L, different operator functions 250 denoted by τ, can be applied. This application can be understood as applying the function to the spectrum of the operator when the operator is linear.

The operator function 250, denoted by τ, is expressed in terms of simple operations involving one or more local operators L₁, . . . , L_{K}, such as:
scalar multiplication aL, where a is a real or complex scalar;
nonlinear scalar function applied element-wise ƒ(L);
operator addition L₁+L₂;
operator multiplication (or composition) L₂L₁, understood as a sequential application of L₁ followed by L₂;
operator inversion L⁻¹;
   and any combination thereof. It is important to note that such application is possible even for non-trivial cases, that is where a scalar multiplication is neither a multiplication by unity or zero.

As an example, consider an embodiment of the invention where the operator function τ is a multi-variate polynomial of degree p w.r.t. multiple operators L₁, . . . , L_{K},

$$τ ( {L}_{1} , … , {L}_{K} ) = {\sum }_{j = 0}^{p} {θ}_{{k}_{1} , … , {k}_{j}} {\sum }_{{k}_{1} , … , {k}_{j} ∈ \{ 1 , … , K \}} {L}_{{k}_{j}} \cdot … \cdot {L}_{{k}_{1}} \qquad ( 7 )$$

where the convention is that for j=−0 we have a zero-degree term θ₀I. A polynomial of the form (7) has

$$\frac{1 + {K}^{p + 1}}{1 - K}$$

coefficients; in some embodiment, it might be beneficial to make the coefficients dependent to reduce the number of free parameters.

In another embodiment of the invention, the operator function τ may be a Padé rational function of the form

$$τ ( L ) = {θ}_{0} + {\sum }_{j = 1}^{p} {{θ}_{j} ( I + {β}_{j} L )}^{- 1} \qquad ( 8 )$$

where θⱼ, βⱼ are the learnable parameters. A multi-variate version of (8) can also easily be used by a person skilled in art.

In some embodiments of the invention, more than a single operator function τ₁, . . . , τ_{M} may be used, each of which having different, shared, or partially shared learnable parameters.

The suggested use of a local operator 200 and an operator function 250 allows implementation of a large variety of embodiments and several preferred embodiments shall be described hereinafter.

In one of the embodiments of the invention, processing operators based on small subgraphs (called motifs) are used, allowing to handle both directed and undirected graphs.

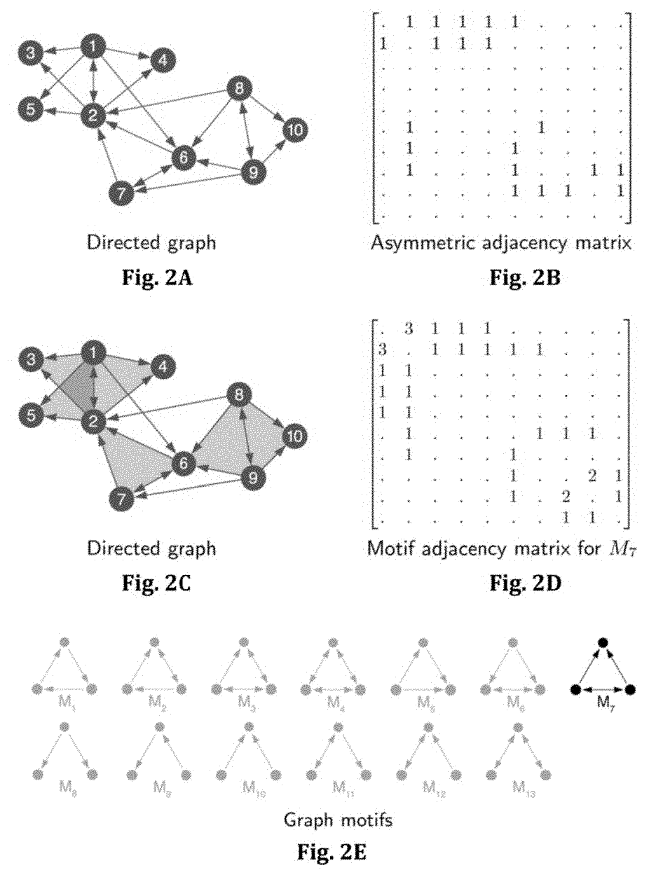

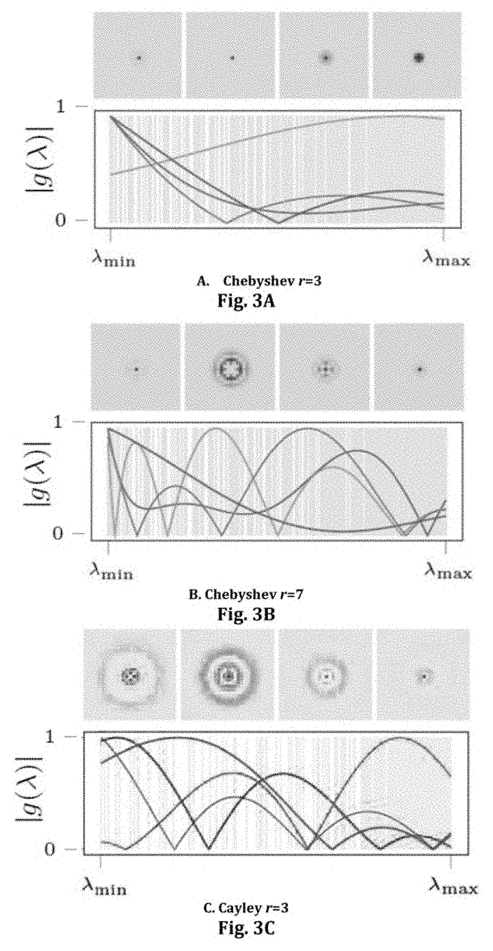

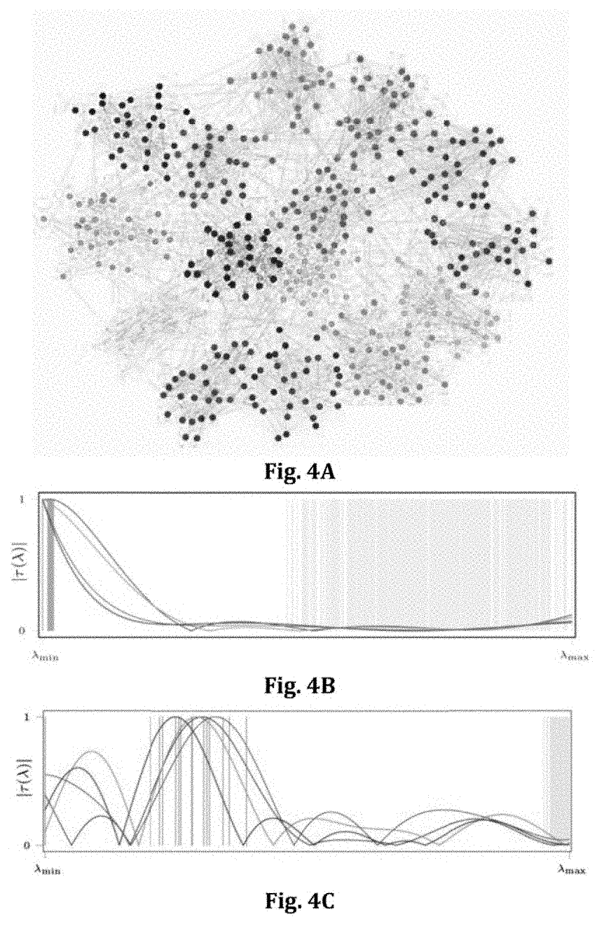

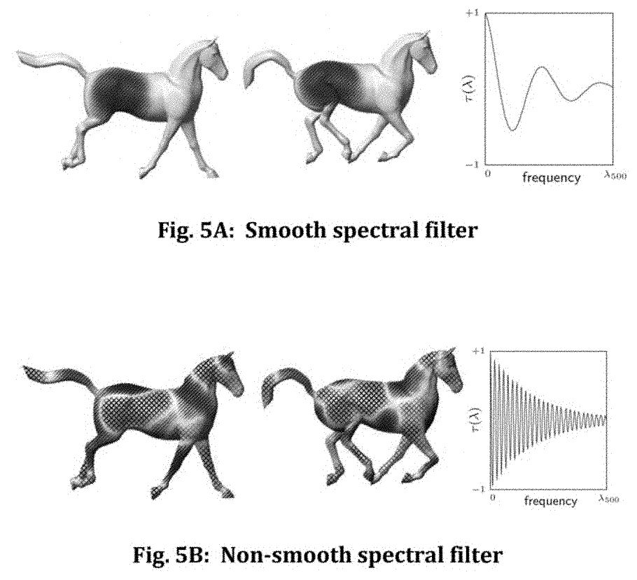

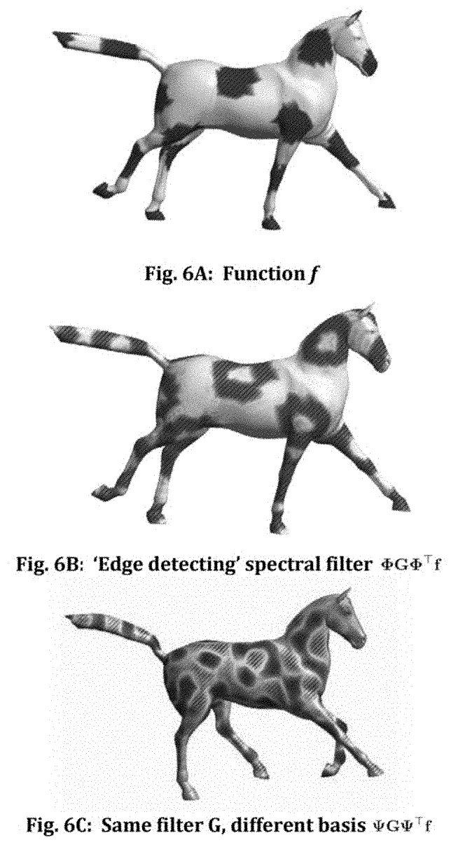

Let [symbol] ={ [symbol] , [symbol] , W} be a weighted directed graph (in which case W^{⊥}≠W, or at least not necessarily so), and let [symbol] ₁, . . . . , [symbol] _{K} denote a collection of graph motifs (small directed or undirected graphs representing certain meaningful connectivity patterns; an example in FIG. 2E depicts thirteen 3-vertex motifs).

For each edge (i,j)∈ [symbol] of the directed graph [symbol] and each motif [symbol] ₖ, let u_{k,ij} denote the number of times the edge (i,j) participates in [symbol] ₖ (note that an edge can participate in multiple motifs, as shown in FIGS. 2C & 2D, where edge (1,2) participates in 3 instances of the motif [symbol] ₇).

We define a new set of edge weights of the form \tilde{w}_{k,ij}=u_{k,ij}wᵢⱼ, which is now a symmetric motif adjacency matrix we denote by \tilde{W}ₖ (a reference is made to A. R. Benson, D. F. Gleich, and J. Leskovec, “Higher-order organization of complex networks,” Science 353(6295):163-166, 2016).

The motif Laplacian \tilde{Δ}ₖ=I−\tilde{D}ₖ^{-1/2} \tilde{W}ₖ\tilde{D}ₖ^{-1/2} associated with this adjacency acts anisotropically with a preferred direction along structures associated with the respective motif.

In one of the embodiments of the invention, the multivariate polynomial (7) w.r.t. the K motif Laplacians \tilde{Δ}₁, . . . , \tilde{Δ}_{K} is used as the operator function τ. To reduce the number of coefficients, in some of the embodiments of the invention, a simplified version of the multivariate polynomial (7) can be used involving only two motifs, e.g. incoming and outgoing directed edges

τ(\tilde{Δ}₁,\tilde{Δ}₂)=θ₀I+θ₁\tilde{Δ}₁+θ₂\tilde{Δ}₂+θ₁₁\tilde{Δ}₁²+ . . . +θ₂₂\tilde{Δ}₂²+ . . . (9)

In another embodiment of the invention, recursive definition of polynomial (7) can be used,

$$τ ( {\tilde{Δ}}_{1} , … , {\tilde{Δ}}_{K} ) = {\sum }_{j = 0}^{p} {θ}_{j} {P}_{j} ; \\ {P}_{j} = {\sum }_{k = 1}^{K} {α}_{k , j} {\tilde{Δ}}_{k} {P}_{j - 1} , j = 1 , … , p \\ {P}_{0} = I , \qquad$$

In a further embodiment of the invention, the operator function τ is a Cayley rational function (or Cayley polynomial).

A Cayley polynomial of order p is a real-valued function with complex coefficients,

$${τ}_{c , h} ( λ ) = {c}_{0} + Re \{ {\sum }_{j = 1}^{p} {{c}_{j} ( h λ - ι )}^{j} {( h λ + ι )}^{- j} \} \qquad ( 10 )$$

where
t=\sqrt{−1} denotes the imaginary unit,
c is a vector of one real coefficient and p complex coefficients and
h>0 is a parameter called the spectral zoom parameter, that will be discussed herein later.

When defining an operator function based on such a polynomial, all or some of these parameters can be optimized during training. This operator function can implement a so called Cayley filter G which is a spectral filter defined by applying the Cayley polynomial to a Laplacian operator (or, more general, any local operator), which is then multiplied by the input data vector x,

$$Gx = {τ}_{c , h} ( Δ ) x = {c}_{0} x + Re \{ {\sum }_{j = 1}^{p} {{c}_{j} ( h Δ - ι I )}^{j} {( h Δ + ι I )}^{- j} x \} \qquad ( 11 )$$

Similarly to polynomial (Chebyshev) filters, Cayley filters involve basic matrix operations such as powers, additions, multiplications by scalars, and also inversions. However, the present filter according to the invention can be applied such that application of the filter Gx can be performed without explicit computationally expensive eigendecomposition of the Laplacian operator. Hence, the present invention allows applying this filter in a manner that is not computationally expensive and hence can be executed in a manner having comparatively low energy consumption, requiring low memory bandwidth and memory size and yielding results in a particular fast manner given a specific processing power.

In the following, it is shown that Cayley filters are analytically well behaved; in particular, it will be seen that any smooth spectral filter can be represented as a Cayley polynomial, and that low-order filters are localized in the spatial domain. Thus, a method of feature extraction using such filters is particularly advantageous and efficient systems for implementing these filters can be provided easily. We also discuss numerical implementation and compare Cayley and Chebyshev filters.

Cayley filters are best understood through the Cayley transform, from which their name derives.

Denote by [symbol] ={e^{iθ}: θ∈ [symbol] } the unit complex circle. Then, the Cayley transform

$$𝒞 ( x ) = \frac{x - ι}{x + ι}$$

is a smooth bijection between [symbol] and [symbol] \{1}. Using this, the complex matrix [symbol] (hΔ)=(hΔ−iI)(hΔ+iI)⁻¹ obtained by applying the Cayley transform to a scaled Laplacian hΔ has its spectrum in [symbol] and is thus unitary.

Furthermore, since z⁻¹=z̅ for z∈ [symbol] , we can write [symbol] =c̅ⱼ̅ [symbol] ^{-j}(hΔ). Therefore, using 2Re{z}=z+z̅, an Caley filter (11) can be written as a conjugate-even Laurent polynomial w.r.t [symbol] (hΔ),

$$G = {c}_{0} I + {\sum }_{j = 1}^{p} {c}_{j} {𝒞}^{j} ( h Δ ) + {\overline{c}}_{J} {𝒞}^{- j} ( h Δ ) \qquad ( 12 )$$

Since the spectrum of [symbol] (hΔ) is in [symbol] , the operator [symbol] (hΔ) can be thought of as a multiplication by a pure harmonic in the frequency domain [symbol] for any integer power j, and hence

$${𝒞}^{j} ( h Δ ) = Φ [ \begin{matrix}{𝒞}^{j} ( h {λ}_{1} ) & & \\ & ⋱ & \\ & & {𝒞}^{j} ( h {λ}_{n} )\end{matrix} ] {Φ}^{T}$$

A Cayley filter can be thus be regarded as a multiplication by a finite Fourier expansion in the frequency domain [symbol] Since (12) is conjugate-even, it is a (real-valued) trigonometric polynomial.

Note that any spectral filter can be formulated as a Cayley filter. Indeed, spectral filters τ(λ) are specified by the finite sequence of values τ(λ₁), . . . , τ(λₙ), which can be interpolated by a trigonometric polynomial.

Moreover, since trigonometric polynomials are smooth, low order Cayley filters can be expected to be well localized in some sense on the graph, as discussed later.

Finally, in definition (10) complex coefficients have been used. Now, if cⱼ∈ [symbol] then (12) is an even cosine polynomial, and if cⱼ∈i [symbol] then (12) is an odd sine polynomial. Since the spectrum of hΔ is in [symbol] ⁺∪{0}, it is mapped to the lower half-circle by [symbol] , on which both cosine and sine polynomials are complete and can represent any spectral filter.

However, it is beneficial to use general complex coefficients, since complex Fourier expansions are overcomplete in the lower half-circle, thus describing a larger variety of spectral filters of the same order without increasing the computational complexity of the filter.

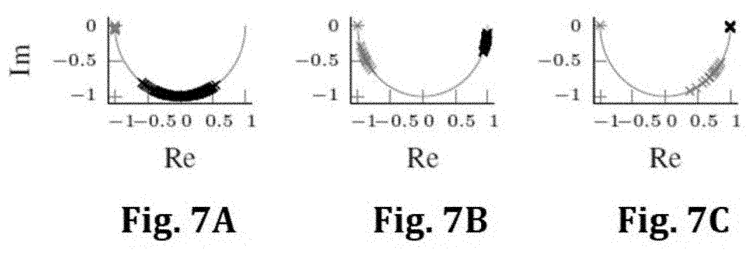

To understand the essential role of the parameter h in the Cayley filter, consider [symbol] (hΔ). Multiplying Δ by h dilates its spectrum, and applying [symbol] on the result maps the non-negative spectrum to the complex half-circle. The greater h is, the more the spectrum of hΔ is spread apart in [symbol] ₊∪{0}, resulting in better spacing of the smaller eigenvalues 300 of [symbol] (hΔ). On the other hand, the smaller h is, the further away the high frequencies of hΔ are from ∞, the better spread apart are the high frequencies of [symbol] (hΔ) in [symbol] (the spectrum of [symbol] (hΔ) for different values of h=0.1, 1, and 10 is shown in FIGS. 7A, 7B & 7C, respectively). Tuning the parameter h allows thus to ‘zoom’ in to different parts of the spectrum, resulting in filters specialized in different frequency bands.

The numerical core of the Cayley filter is the computation of [symbol] ^{j}(hΔ)x for j=1, . . . , p performed in a sequential manner.

In more detail, let y₀, . . . , yₚ denote the solutions of the following linear recursive system,

$$\begin{matrix}{y}_{0} = x & ( 13 ) \\ ( h Δ + ι I ) {y}_{j} = ( h Δ - ι I ) {y}_{j - 1} , j = 1 , … , p & \end{matrix}$$

Note that sequentially approximating yⱼ in equation (13) using the approximation of yⱼ₋₁ in the right hand side is stable, since [symbol] (hΔ) is unitary and thus has condition number 1.

The recursive equations (13) can be solved with matrix inversion exactly, but it costs O(n³). However, solving the matrix inversion exactly usually is not necessary in the present invention for almost every application. A more simple alternative is to use an iterative approach such as the Jacobi method, which provides approximate solutions \tilde{y}ⱼ≈yⱼ.

The Jacobi method for solving Ax=b consists in decomposing A into its diagonal and off-diagonal elements

A=Diag(A)+Off(A)

and obtaining the solution iteratively as

x^{(k+1)}=−(Diag(A))⁻¹Off(A)x^{(k)}+(Diag(A))⁻¹b.

If J=−(Diag(hΔ+iI))⁻¹Off(hΔ+d) designates the Jacobi iteration matrix associated with equation (13), then, for the unnormalized Laplacian,

J=(Diag(hD+iI))⁻¹hW.

Jacobi iterations for approximating (13) for a given j have the form

\tilde{y}ⱼ^{(k+1)}=J\tilde{y}ⱼ^{(k)}+bⱼ, bⱼ=(Diag(hΔ+iI))⁻¹(hΔ−iI)\tilde{y}ⱼ₋₁

initialized with \tilde{y}ⱼ⁽⁰⁾=bⱼ and terminated after K iterations, yielding \tilde{y}ⱼ=\tilde{y}ⱼ^{(K)}.

This can be used to approximate the application of the Cayley filter. The application of the approximate Cayley filter is given by

\tilde{G}x=Σⱼ₌₀^{p}cⱼ\tilde{y}ⱼ≈Gx,

and takes O(pKn)-O(n) operations under the assumption of a sparse Laplacian. This assumption is valid in a very large number of cases. Accordingly, despite having a localized behavior, the application of the method according to the invention is possible in a computationally non-expensive manner.

It should be noted that in some of the embodiments, the method can even be further improved by normalizing ∥\tilde{y}ⱼ∥=∥x∥.

Furthermore, an error bound for the approximate filter can be given in most of the relevant cases. For the unnormalized Laplacian, let

$$d = {max}_{j} {d}_{jj}$$

$$and$$

$$κ = {‖ J ‖}_{∞} = \frac{hd}{\sqrt{{h}^{2} {d}^{2} + 1}} < 1.$$

For the normalized Laplacian, in a large number of cases it can be assumed that (hΔ+iI) is dominant diagonal, which gives K=∥J∥_{∞}<1.

Under the above assumptions, it can be shown that he following error bound can be established

$$\frac{{‖ \tilde{G} x - Gx ‖}_{2}}{{‖ x ‖}_{2}} < M {κ}^{K}$$

where
M=\sqrt{n}Σⱼ₌₁^{p}j|cⱼ| in the general case,
and M=Σⱼ₌₁^{p}j|cⱼ| if the graph is regular.

This estimate is pessimistic in the general case, while it requires strong assumptions in the regular case. However, in most real life situations the behavior is closer to the regular case. It also follows that smaller values of the spectral zoom h result in faster convergence, giving this parameter an additional numerical role of accelerating convergence.

When applying this approach in a trained neural network, in practice, an accurate inversion of (hΔ+iI) is found to be not required at all, since the approximate inverse suggested is combined with learned coefficients, which are found to “compensate”, as necessary, for any inversion inaccuracy. FIG. 9 illustrates this on the community detection in a community graph, showing that as few as a a single Jacobi iteration (curve “1”) is sufficient to achieve performance superior to conventional polynomial (ChebNet) filters. Hence, the same or better precision is obtained by a significantly less computationally expensive approach.

In a CayleyNet for a fixed graph, it is thus preferred to fix the number of Jacobi iterations. Since the convergence rate depends on K, that depends on the graph, different graphs may need different numbers of iterations. It is noted that the convergence rate also depends on h. Since there is a trade-off between the spectral zoom amount h, and the accuracy of the approximate inversion, and since h is a learnable parameter, the training will find the right balance between the spectral zoom amount and the inversion accuracy.

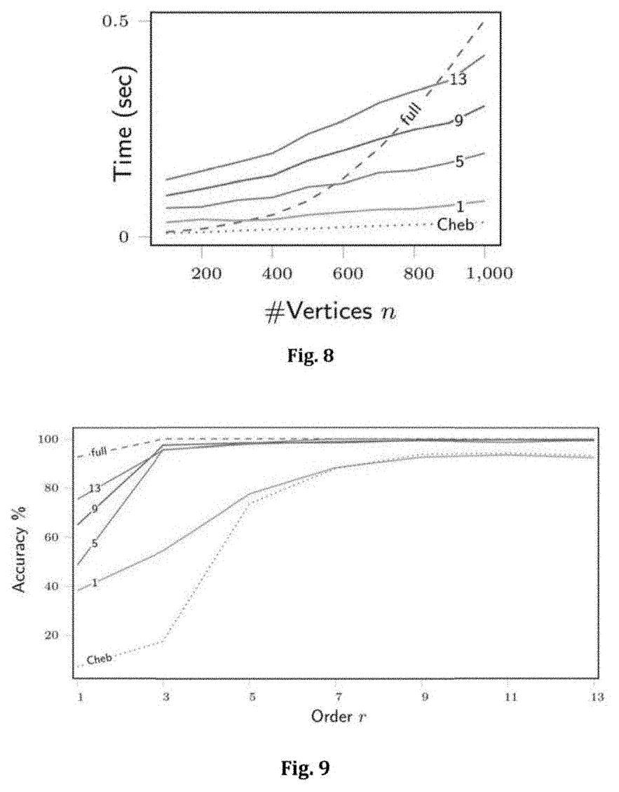

In order to assess the method of the invention, the computational complexity of the method, was studied as the number of edges n of the graph tends to infinity. This is shown in FIG. 8. FIG. 8 shows the time needed for a given calculation as a function of the size of a graph as defined by the number of vertices n the graph has. For every constant of a graph, e.g. d, κ, was added with the subscript n indicating the number of edges of the graph.

For the unnormalized Laplacian, it is assumed that d, κₙ are bounded, which gives κₙ<a<1 for some a independent of n. For the normalized Laplacian, it can be assume that κₙ<a<1.

Fixing the number of Jacobi iterations K and the order of the filter p, independently of n, then keeps the Jacobi error controlled. As a result, the number of parameters is O(1), and for a Laplacian modeled as a sparse matrix, applying a Cayley filter on a signal takes O(n) operations. FIG. 8 demonstrates the corresponding linear growth of complexity.

Unlike polynomial (Chebyshev) filters of the form (4) that have the small p-hop support, Cayley filters are rational functions supported on the whole graph. However, it is still true that Cayley filters are well localized on the graph.

If G designates a Cayley filter and δₘ denotes a delta-function on the graph, defined as one at vertex m and zero elsewhere, it can be shown that that Gδₘ decays fast, in the following sense:

Let
x is a signal on the vertices of graph G, 1≤q≤∞ and 0<ε<1.
   and let
S⊆{1, . . . , n} denote a subset of the vertices
   and let
S^{c}⊆{1, . . . , n}\S be its set-theoretic complement. W

Then, the L_{q}-mass of x is said to be supported in S up to ε if ∥x|s^{c}∥_{q}≤ε∥x∥_{q}, where x|s^{c}=(xₗ)_{l∈S}_{^{c}} is the restriction of x to S^{c}. and x is said to have a (graph) exponential decay about vertex m, if there exists some 0<γ<1 and c>0 such that for any k, the L_{q}-mass of x is supported in [symbol] _{k,m} up to cγ^{k}.

Here, [symbol] _{k,m} is the k-hop neighborhood of m.

Using this definition, for a Cayley filter G of order p,

Gδₘ has exponential decay about m in L₂, with constants

$$c = 2 M \frac{1}{{‖ G {δ}_{m} ‖}_{2}} and γ = {κ}^{1 / p}$$

(with M and κ as indicated above).

It should be noted that in some embodiments, the methods and processes described herein are embodied as code and/or data that are executable on a programmable or configurable system.

The software code and data described herein can be stored on one or more machine-readable media (e.g., computer-readable media), which may include any device or medium that can store code and/or data for use by a computer or other data processing system. The data carrier can be integrated with or separable from such computer or other data processing system. In particular, the data carrier may be spaced apart from the computer or other data processing system.

When a computer system or other system reads or requests the code and/or data stored on a computer-readable medium, the computer system or other data processing system may perform the methods and processes embodied as data structures and/or code stored within the computer-readable storage medium.

It will be appreciated by those skilled in the art that machine-readable media (e.g., computer-readable media) may include inter alia removable or non-removable structures/devices that can be used for storage of information, such as information relating, constituting or corresponding to computer-readable instructions, data structures, program modules, and other data used by a computing system/environment. A computer-readable medium may include, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed capable of storing computer-readable information/data. Computer-readable media should not be construed or interpreted to include any propagating signals.

A computer-readable medium that can be used with embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto.

A computing device can be, for example, a laptop computer, desktop computer, server, cell phone, or tablet, though embodiments are not limited thereto.

It will be noted that any such data processing system will have at least one interface adapted to be used as a data input and/or as a data output, a memory used for storing at least input data, intermediate and final results, a data storage for storing instructions and constants necessary to perform the methods and processes described herein, at least one data processing device that may for example be a programmable data processing device such as a central processing unit CPU and/or a graphics processing unit and/or a configurable data processing unit such as an FPGA and the data processing system will have a power supply providing energy to allow the operation of the different parts of the system.

It will be understood by the average skilled person that the bandwidth with which the memory can be accessed by the data processor will have some finite value, that the precision of a given mathematical operation will be limited, that the time needed to obtain a result of given precision is having a minimum length dependent inter alia on the way the result is to be achieved, the number and complexity of operations to be executed by the system and in particular by the CPU, GPU, FPGA and/or other data processing device, the number of memory accesses necessary to store intermediate results, retrieve constants, store final results asf. and that the overall power consumption will strongly depend on a number of these parameters. It will also be understood that any bottleneck or problem with respect to any of the technical parameters mentioned becomes far more pronounced where a larger amount of data needs to be processed. In this respect, it will be understood by the description above that the method described, despite the high overall precision of results obtainable, can be achieved in a manner requiring an extremely low consumption of power by a given system while still providing the results in a competitive time even for a large amount of data.

It will be understood that in some embodiments, one, more or all of the steps performed in any of the methods of the subject invention can be performed by a single processor or processor core or can be distributed to a plurality of processors and/or processor cores. In particular, it will be noted that the method of the present invention lends itself particularly well to execution on a device supporting data processing with a high degree of parallelism such as a modern GPU or FPGA. For example, any or all of the means for applying one or more intrinsic or other processing layers can include or be a processor (e.g., a computer processor) or other computing device.

1. A method for extracting hierarchical features from input data defined on a geometric domain,
the method comprising
applying at least one intrinsic local processing layer
on local processing layer input data,
at least a part of which being
derived from or corresponding to input data
and comprising
central point input data,
neighbour point input data,
and neighbour edge input data,
to obtain intrinsic local processing layer output data
by
inputting intrinsic local processing layer input data into the intrinsic local
processing layer;
applying at least one local operator; and
applying at least one operator function,
wherein
said at least one local operator is applied to at least some of the intrinsic local processing layer input data in a manner comprising die steps of
applying at least a local processing function to at least some of the central point input data, neighbour point input data, and neighbour edge input data
applying a local aggregation operation to aggregate at least one of the results of said local processing functions
using at least said local aggregation operation result to output an output feature corresponding to said point
and wherein
said operator function comprises applying to said at least one local operator at least one or more of the following operations
multiplication by a non-trivial real or complex scalar
nonlinear scalar function
operator addition
operator multiplication
operator composition
operator inversion
and wherein the intrinsic local processing layer output data is used to extract the hierarchical features.

2. A method of claim 1, wherein applying the local processing function further comprises
applying a central point function to at least some of the central point input data to compute a central point feature;
for at least some of the neighbour points, applying a neighbour point function to at least some of the neighbour point input data to compute a neighbour point feature;
for at least some of the neighbour points, applying an edge function to at least some of the pairs of at least central point feature and neighbour point feature, to compute a neighbour edge feature;
applying a local aggregation operation to aggregate at least some of said neighbour edge features;
using at least said local aggregation operation result to output the output feature corresponding to said point.

3. A method according to claim 1, wherein the intrinsic local processing layer comprises
first applying the at least one local operator
and then applying the at least one operator function.

4. The method according to claim 1, wherein at least one of the operator functions is at least one of the following
a polynomial;
a rational function;
a Cayley polynomial;
a Padé function.

5. The method according to claim 1, wherein at least one intrinsic local processing layer comprises more than one local operator, and wherein the at least one of the operator function is a multivariate function applied to more than one local operator,
in particular wherein at least one of the multivariate functions is a one of the following
a multivariate polynomial;
a multivariate rational function;
a multivariate Cayley polynomial;
a multivariate Padé function.

6. The method according to claim 1, wherein the at least one local operator is at least one of the following
graph Laplacian operator;
graph motif Laplacian operator;
point-cloud Laplacian operator;
manifold Laplace-Beltrami operator;
mesh Laplacian operator,
in particular
wherein a plurality of local processing operators are applied and wherein at least some of the local processing operators are graph motif Laplacian operators corresponding to a plurality of graph motifs, and at least one operator function is a multivariate function applied to said graph motif Laplacian operators.

7. The method according to claim 1, wherein a plurality of local processing functions are applied and wherein at least some of the local processing functions are parametric functions,
and/or wherein they are implemented as neural networks.

8. The method according to claim 2, wherein at least some of the
central point functions;
neighbor point functions; and
edge functions
are parametric functions
and/or are implemented as neural networks.

9. The method according to claim 1, wherein at least one of the operations effected by at least one operator function on the at least one local operator includes an operator inversion and the operator inversion is carried out in an iterative manner,
in particular such that where the number of iterations is fixed and/or such that the operator inversion is carried out by means of one of
a Jacobi method;
a conjugate gradients method;
a preconditioned conjugate gradients method;
a Gauss-Seidel method;
a minimal residue method;
a multigrid method.

10. The method according to claim 9, wherein at least some iterations of the iterative algorithm used to carry out the operator inversion are implemented as layers of a neural network.

11. The method of claim 1, where the geometric domain is at least one of the following:
a manifold;
a parametric surface;
an implicit surface;
a mesh;
a point cloud;
a directed graph;
an undirected graph;
a heterogenous graph.

12. The method of claim 1, where the input data defined on a geometric domain comprises at least one of vertex input data and edge input data.

13. The method according to claim 1, where the at least one local aggregation operation is at least one or more of the following:
a permutation invariant function;
a weighted sum;
a sum;
an average;
a maximum;
a minimum;
an Lp-norm;
a parametric function;
a neural network.

14. The method according to claim 1, where the at least one local aggregation operation is a parametric function.

15. The method according to claim 1, where the at least one local aggregation operation is implemented as a neural network.

16. The method according to claim 1, further comprising applying at least one of the following layers:
a linear layer or fully connected layer, outputting a weighted linear combination of layer input data;
a non-linear layer, including applying a non-linear function to layer input data;
a spatial pooling layer, including:
determining a subset of points on the geometric domain,
determining for each point of said subset,
neighbouring points on the geometric domain,
and
computing a local aggregation operation
on layer input data over the neighbours for all the points of said subset;
a covariance layer, including computing a covariance matrix of input data over at least some of the points of the geometric domain;
and wherein each layer has input data and output data, and wherein output data of one layer are forwarded as input data to another layer.

17. The method of claim 1, wherein the applied layer has parameters, said parameters comprising at least one or more of the following:
weights and biases of the linear layers;
parameters of the intrinsic local processing layers, comprising at least one or more of the following:
parameters of the local processing operators;
parameters of the local processing functions;
parameters of the local aggregation operations;
parameters of the central point functions;
parameters of the neighbour point functions;
parameters of the edge functions;
parameters of the operator functions;

18. The method of claim 17, where parameters of the operator function comprise at least one or more of the following:
coefficients of a polynomial;
coefficients of a multivariate polynomial;
coefficients of a Cayley polynomial;
coefficients of a multivariate Cayley polynomial;
coefficients of a Padé function;
coefficients of a multivariate Padé function;
spectral zoom;
in particular
wherein parameters of the applied layers are determined by minimizing a cost function by means of an optimization procedure.

19. A system for extracting hierarchical features from a set of data defined on a geometric domain, the system comprising
at least one interface for inputting input data into the system and for outputting output data by the system,
the system further comprising
means for applying at least one intrinsic local processing layer on local processing layer input data,
means for determining the local processing layer input data in response to input data and and comprising central point input data, neighbour point input data, and neighbour edge input data
to obtain intrinsic local processing layer output data,
the means for applying at least one intrinsic local processing layer on local processing layer input data being adapted
to input intrinsic local processing layer input data into the intrinsic local processing layer;
to apply at least one local operator; and
to apply at least one operator function;
and being adapted such that
said at least one local operator is applied to at least some of the intrinsic local processing layer input data in a manner comprising
applying at least a local processing function to at least some of the central point input data, neighbour point input data, and neighbour edge input data,
applying a local aggregation operation to aggregate at least one of the results of said local processing functions,
using at least said local aggregation operation result to output an output feature corresponding to said point
and such that
said operator function comprises applying to said at least one local operator at least one or more of the following operations
multiplication by a non-trivial real or complex scalar,
nonlinear scalar function,
operator addition,
operator multiplication,
operator composition,
operator inversion,
and wherein the means for applying said at least one intrinsic local processing layer on local processing layer input data being adapted to use the intrinsic local processing layer output data to extract the hierarchical feature.

20. A system according to claim 19, comprising
means for applying a plurality of at least a first and a second layer in a sequential manner such that the first layer is applied first and the second layer is applied thereafter,
and furthermore comprising a means for allowing use of the output data of the first layer to determine input data to the second layer and configured such that
different data processing devices are provided for applying the first layer and the second layer respectively
and a communication path is provided to propagate the output data of the first layer towards the second layer, so that input data to the second layer can be determined therefrom;
and/or such that
a storage is provided for storing output data of the first layer so that input data into the second layer can be determined at later time by retrieving the stored output data from the storage.
